(19) United States
(12) Patent Application Publication
(10) Pub. No.: US 2007/0242721 A1
(43) Pub. Date: Oct. 18, 2007

(54) METHOD FOR MEASURING THICKNESS OF THERMAL GREASE AND MEASURING SYSTEM AND MEASURING MODULE USING THE SAME

(75) Inventors: Che-Hsi Lin, Taipei (TW); Teng-Nan Lo, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/735,439

(22) Filed: Apr. 14, 2007

(30) Foreign Application Priority Data
Apr. 17, 2006 (TW) 95113604

(51) Int. Cl. G01N 25/00

(52) U.S. Cl. 374/7

(57) ABSTRACT

A method for measuring the thickness of the thermal grease is provided. A heat dissipation module, suitable for dissipating heat from a chip, is provided. The heat dissipation module has a surface provided with a chip bonding area. A layer of thermal grease is coated on the chip bonding area. A first measuring point is selected from an area of the surface outside the chip bonding area, and a second measuring point is selected from the top surface of the thermal grease. A non-contact measuring device is provided. Then the non-contact measuring device is disposed above the thermal grease, and the first measuring point and the second measuring point are measured by using the non-contact measuring device to respectively obtain a first measuring value and a second measuring value. The first measuring value is compared with the second measuring value, so as to obtain the thickness of the thermal grease.

### CROSS-REFERENCE TO RELATED APPLICATIONS

This application claims the priority benefit of Taiwan application serial no. 95113604, filed Apr. 17, 2006. All disclosure of the Taiwan application is incorporated herein by reference.

### BACKGROUND OF THE INVENTION

1. Field of Invention

The present invention relates to a method for measuring the size of a soft material. More particularly, the present invention relates to a method for measuring the thickness of thermal grease.

2. Description of Related Art

With the continuing increase in integration and amount of heat generated by devices inside integrated circuit (IC) chips, central processor units, graphic chips, and the chipsets etc, of personal computers, which are electronic devices having chips, may generate thermal energy in high-speed operation, thus raising the temperature of the electronic devices. In order to maintain that the chips of the electronic elements may operate normally for a long period of time in a high-speed operation state, the thermal energy generated by the chips of the electronic devices in Ugh-speed operation must be dissipated quickly, so as to keep the temperature of the chips in a predetermined temperature range. If the heat dissipation from a chip is slower than the heat generation of the chip, a failure of the chip may occur because of overheating, thus resulting in the breakdown of the computer system. In order to quickly dissipate the heat generated by a chip, manufacturers usually dispose the surface of a heat dissipation module on the back of the chip.

Generally speaking, chips are usually disposed on the carrying surface of a carrier, and are electrically connected to the carrier. The carrier is disposed on the motherboard of personal computers and electrically, connected to the motherboard. For example, chips can be electrically connected to the carrier via a plurality of bumps on the active surface relative to the back and through the flip chip bounding process. The carrier can be electrically connected to the motherboard via a plurality of solder balls on the bottom relative to the carrying surface.

Due to the precision of manufacturing techniques (such as, tolerance of solder balls, warping of the carrier, and other variables), compared with the motherboard, the carrying surface of the carrier usually is inclined. If a heat dissipation module is directly disposed on the chip, a gap may be generated between the back of the chip and the surface of the heat dissipation module, and thus the heat generated by the chip may not be successfully exhausted to the heat dissipation module.

In order to solve the above problem, a conventional technique dispose a layer of thermal grease on the back of the chip by a screen printing technique, and then presses the surface of the heat dissipation module to the backs of the chip. Since the thermal grease has a high thermal conductivity coefficient and the properties of fluid, when the surface of the heat dissipation module is pressed towards the back of the chip, the thermal grease is filled into the gap between the surface of the heat dissipation module and the back of the chip, and can be used to quickly conduct the heat of the chip to the heat dissipation module.

It should be noted that since the thickness of the thermal grease must exceed a specific value to fill up the gap between the surface of the heat dissipation module and the back of the chip, the thickness or the thermal grease is one of the main factors to decide whether the heat dissipation module can fully exert the effect of dissipation or not. Therefore, how to measure the thickness of the thermal grease has become an urgent problem to be solved.

### SUMMARY OF THE INVENTION

Accordingly, an objective of the present invention is to provide a method for measuring the thickness of the thermal grease.

The present invention provides a method for measuring the thickness of the thermal grease. First, a heat dissipation module, suitable for dissipating heat from a chip, is provided. The heat dissipation module has a surface provided with a chip bonding area. A layer of thermal grease is coated on the chip bonding area. Next, a first measuring point is selected from an area of the surface outside the chip bonding area, and a second measuring point is selected from the top surface of the thermal grease. Then, a non-contact measuring device is provided. After that, the non-contact measuring device is disposed above the thermal grease, and the first measuring point and the second measuring point are measured by using the non-contact measuring device to respectively obtain a first measuring value and a second measuring value. The first measuring value is compared with the second measuring value, so as to obtain the thickness of the thermal grease.

According to the method for measuring the thickness of the thermal grease described in an embodiment of the present invention, the non-contract measuring device is an optical measuring device, and the optical measuring device is suitable for emitting and receiving a laser beam.

According to the method for measuring the thickness of the thermal grease described in an embodiment of the present invention, when the non-contact measuring device is an optical measuring device, the optical measuring device is suitable for emitting and receiving the laser beam.

According to the method for measuring the thickness of the thermal grease described in an embodiment of the present invention, when the non-contact measuring device is an optical measuring device, the optical measuring device emits the laser beam to the first measuring point and senses the laser beam reflected from the first measuring point, so as to obtain the first measuring value.

According to the method for measuring the thickness of the thermal grease described in an embodiment of the present invention, when the non-contact measuring device is an optical measuring device, the optical measuring device emits the laser beam to the second measuring point and senses the laser beam reflected from the second measuring point, so as to obtain the second measuring value.

According to the method for measuring the thickness of the thermal grease described in an embodiment of the present invention, when the non-contact measuring device is an optical measuring device, the laser bean emitted by the optical measuring device is an infrared laser beam.

The present invention also provides a system for measuring the thickness of the thermal grease, which comprises a heat dissipation module and a non-contact measuring device. The heat dissipation module has a thermal grease. The non-contact measuring device is located above the heat dissipation module. The non-contact measuring device is suitable for measuring the thickness of the thermal grease.

According to the system for measuring the thickness of the thermal grease described in an embodiment of the present invention, the heat dissipation module further has a carrying platform used to move the heat dissipation module.

According to the system for measuring the thickness of the thermal grease described in an embodiment of the present invention, the non-contact measuring device is an optical measuring device suitable for emitting and receiving a laser beam, wherein the laser beam is an infrared laser beam.

According to the system for measuring the thickness of the thermal grease described in an embodiment of the present invention, the non-contact measuring device further has a moving axis used to move the non-contact measuring device.

The present invention further provides a module for measuring the thickness of the thermal grease, which is suitable for measuring the thickness of the thermal grease on a heat dissipation module. The heat dissipation module comprises a chip bonding area. The thermal grease is located in the chip bonding area. The module for measuring the thickness of the thermal grease comprises a carrying platform and a non-contact measuring device. The heat dissipation module is suitable for being disposed on the carrying platform. The non-contact measuring device is disposed above the carrying platform. The non-contact measuring device is suitable for measuring a first measuring point outside the chip bonding area to obtain a first measuring value, and is suitable for measuring a second measuring point on the thermal grease to obtain a second measuring, value. Moreover, the non-contact measuring device is also suitable for comparing the first measuring value with the second measuring value, so as to obtain the thickness of the thermal grease.

According to the module for measuring the thickness of the thermal grease described in an embodiment of the present invention, the non-contact measuring device is an optical measuring device, and the optical measuring device is suitable for emitting and receiving a laser beam.

According to the module for measuring the thickness of the thermal grease described in an embodiment of the present invention, the laser beam emitted by the optical measuring device is an infrared laser beam.

According to the module for measuring the thickness of the thermal grease described in an embodiment of the present invention, the carrying platform is suitable for moving relative to the non-contact measuring device.

Since a non-contact manner is adopted to measure the thickness of the thermal grease, the present invention can exactly measure the thickness of the thermal grease.

In order to the make aforementioned and other objects, features and advantages of the present invention comprehensible, preferred embodiments accompanied with figures are described in detail below.

### BRIEF DESCRIPTION OF THE DRAWINGS

FIG. 1 is a schematic view of a method for measuring the thickness of the thermal grease of an embodiment of the present invention.

FIG. 2 is a schematic view of a module for measuring the thickness of the thermal grease of an embodiment of the present invention.

FIG. 3 is a schematic view of a systems for measuring the thickness of the thermal grease of an embodiment of the present invention.

### DESCRIPTION OF EMBODIMENTS

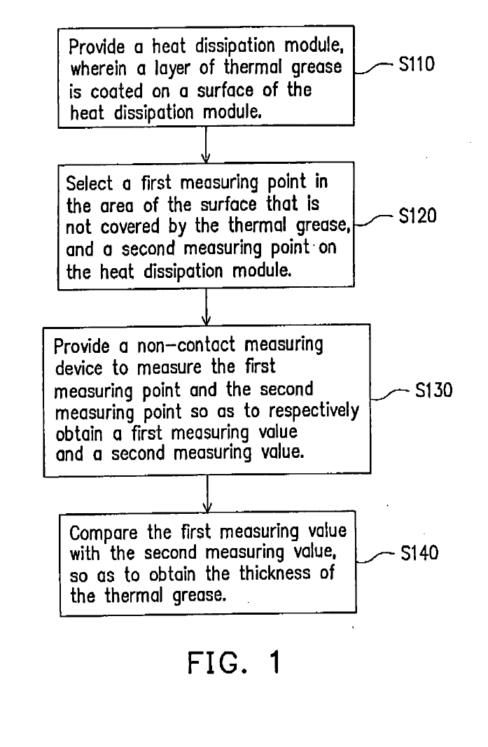

FIG. 1 is a schematic view of a method for measuring the thickness of the thermal grease of an embodiment of the present invention. Referring to FIG. 1, first as shown in step S110, a heat dissipation module is provided. The heat dissipation module has a surface provided with a chip bonding area. A layer of thermal grease is coated in the chip bonding area, wherein the layer of thermal grease is, for example, coated in the chip bonding area bad a screen printing process. Then, as shown in the step S120, a first measuring point and a second measuring point are selected on the surface of the heat dissipation module, wherein the first measuring point is located in the area outside the chip bonding area, and the second measuring point is located on the thermal grease.

Then, as shown in step S130, a non-contact measuring device is provided, wherein the non-contact measuring device is, for example, a radiation measuring device, ultrasonic measuring device, capacitive sensing measuring device, optical measuring device, or other measuring devices that can measure the thickness of the thermal grease without contacting the thermal grease. Then, the non-contact measuring device is disposed above the thermal grease, and the first measuring point and the second measuring point are measured by the non-contact measuring device to respectively obtain a first measuring value and a second measuring value.

Then, as shown in step 140, the first measuring value is compared with the second measuring value, so as to obtain the thickness of the thermal grease.

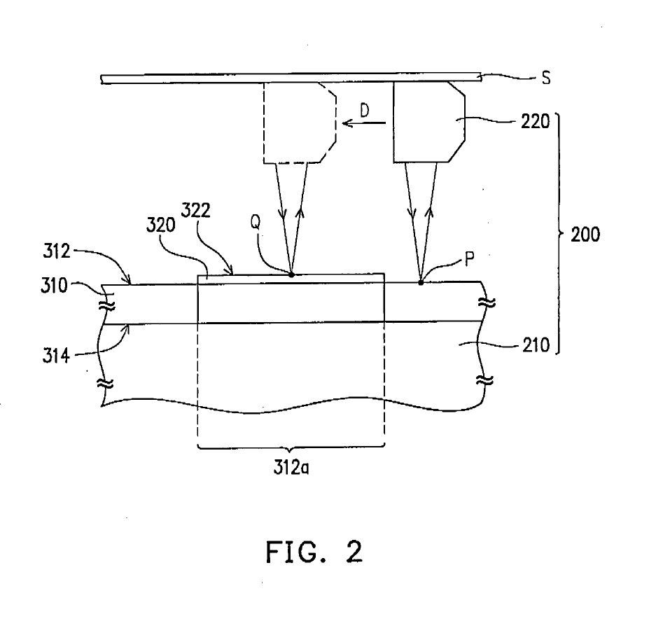

Based on the method, the embodiment further provides a module for measuring the thickness of the thermal grease. Referring to FIG. 2, the module 200 for measuring the thickness of the thermal grease comprises a carrying platform 200 and a non-contact measuring device 220. The carrying platform 210 is suitable for carrying a heat dissipation module 310. The heat dissipation module 310 has a surface 312 and a back 314 opposite to each other. The surface 312 has a chip bonding area 312a. A layer of thermal grease 320 is coated on the surface 312 wherein the thermal grease 320 is disposed in the chip bonding area 312a. When the carrying platform 210 carries the heat dissipation module 310, the back 314 of the heat dissipation module 310 faces the carrying platform 210 and is disposed on the carrying platform.

The non-contact measuring device 220 is disposed above the carrying platform 210. For the convenience of illustration, an optical measuring device is taken as an example to illustrate the following non-contact measuring device 220, wherein the optical measuring device is suitable for emitting and receiving the laser beam, and the laser beam is, for example, an infrared laser beam.

The process of using the module 200 for measuring the thickness of the thermal grease to measure the thickness of the thermal grease 320 is given in detailed below. An the heat dissipation 310 coated with the thermal grease 320 is disposed on the carrying platform 210, a first measuring point P is selected from the area of the surface 312 outside the chip bonding area 312a. Then, the non-contact measuring device 220 emits the laser beam to the first measuring point P and senses the laser beam reflected from the first measuring point P to obtain the first measuring value.

Then, a second measuring point Q is selected on a top surface 322 of the thermal grease 320. Then, the non-contact measuring device 220 is made to move along the direction D, and emits the laser beam to the first measuring point P and senses the laser beam reflected from the first measuring point P to obtain the second measuring value. It is obvious to those of ordinary skill in the art that the non-contact measuring device 220 can move relative to the carrying platform 210 in various manners. For example, the non-contact measuring device 220 cam move along the direction D about a moving axis S connected to the non-contact measuring device 220. Definitely, in other embodiments, the carrying platform 210 can also move relative to the non-contact 11) measuring device 220 to adjust the relative position of the heat dissipation module 310 on the carrying platform 210 and the non-contact measuring device 220. Then, the first measuring value is compared with the second measuring value, so as to obtain the thickness of the thermal grease 320.

Definitely, in the present embodiment, a plurality of the first measuring points P and a plurality of the second measuring points Q can be selected and measured to obtain the average thickness of the thermal grease 30 or the thickness of each portion of the thermal grease 320, and the details will not be described herein again.

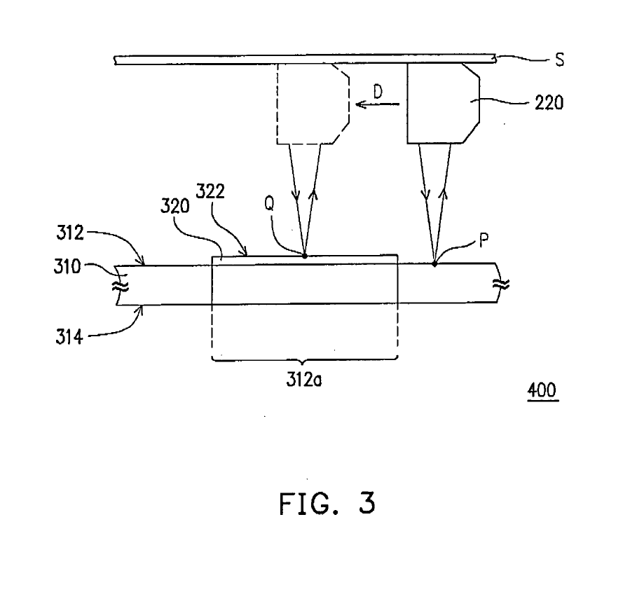

Moreover, in other embodiments of the present invention, the thermal grease 320 on the heat dissipation module 310 further can be directly measured. Referring to FIG. 3, the system 400 for measuring the thickness of the thermal grease mainly comprises a heat dissipation module 310 and a non-contact measuring device 220, wherein the non-contact measuring device 220 is disposed above the heat dissipation module 310. The non-contact measuring device 220 is suitable for moving relative to the carrying platform 210. For example, the non-contact measuring device 220 can move along the direction D about a moving axis S connected to the non-contact measuring device 220. As such, the non-contact measuring device 220 can measure the thickness of the thermal grease 210 in the manner described above.

To sum up, since the method for measuring the thickness of the thermal grease and the module for measuring the thickness of the thermal grease provided bad the present invention can measure the thickness of the thermal grease without contacting the thermal grease, the present invention can exactly measure the thickness of the thermal grease on the heat dissipation module without damaging the profile of the thermal grease.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for measuring the thickness of the thermal grease, comprising:
providing a heat dissipation module suitable for dissipating heat from a chip, wherein the heat dissipation module comprises a surface, the surface has a chip bonding area, and a layer of thermal grease is coated on the chip bonding area;
selecting a first measuring point from an area of the surface outside the chip bonding area, and selecting a second measuring point on the thermal grease;
providing a non-contact measuring device;
disposing the non-contact measuring device above the heat dissipation module, and measuring the first measuring point and the second measuring point by using the non-contact measuring device, so as to respectively obtain a first measuring value and a second measuring value; and
comparing the first measuring value with the second measuring value, so as to obtain the thickness of the thermal grease.

2. The method for measuring the thickness of the thermal grease as claimed in claim 1, wherein the non-contact measuring device is an optical measuring device suitable for emitting and receiving a laser beam.

3. The method for measuring the thickness of the thermal grease as claimed in claim 2, wherein the optical measuring device emits the laser beam to the first measuring point and senses the laser beam reflected from the first measuring point, so as to obtain the first measuring value.

4. The method for measuring the thickness of the thermal grease as claimed in claim 2, wherein the optical measuring device emits the laser beam to the second measuring point and senses the laser beam reflected from the second measuring point, so as to obtain the second measuring value.

5. The method for measuring the thickness of the thermal grease as claimed in claim 1, wherein the laser beam emitted by the optical measuring device is an infrared laser beam.

6. A system for measuring the thickness of the thermal grease, comprising:
a heat dissipation module having a thermal grease; and
a non-contact measuring device disposed above the heat dissipation module, the non-contact measuring device being suitable for measuring the thickness of the thermal grease.

7. The system for measuring the thickness of the thermal grease as claimed in claim 6, wherein the heat dissipation module further comprises a carrying platform used to move the heat dissipation module.

8. The system for measuring the thickness of the thermal grease as claimed in claim 6, wherein the non-contact measuring device is an optical measuring device suitable for emitting and receiving the laser beam.

9. The system for measuring the thickness of the thermal grease as claimed in claim 8, wherein the laser beam emitted by the optical measuring device is an infrared laser beam.

10. The system for measuring the thickness of the thermal grease as claimed in claim 7, wherein the non-contact measuring device further comprises a moving axis to move the non-contact measuring device.

11. A module for measuring the thickness of the thermal grease suitable for measuring the thickness of the thermal grease on a heat dissipation module, wherein the heat dissipation module has a chip bonding area, and the thermal grease is disposed in the chip bonding area, the module for measuring the thickness of the thermal grease comprising:
a carrying platform suitable for carrying the heat dissipation module; and
a non-contact measuring device disposed above the carrying platform, wherein the non-contact measuring device is suitable for measuring a first measuring point disposed outside the chip bonding area to obtain a first measuring value, and is suitable for measuring a second measuring point on the thermal grease to obtain a second measuring value, and is suitable for comparing the first measuring value with the second measuring value to obtain the thickness of the thermal grease.

12. The module for measuring the thickness of the thermal grease as claimed in claimed 11, wherein the non-contact measuring device is an optical measuring device suitable for emitting and receiving the laser beam.

13. The module for measuring the thickness of the thermal grease as claimed in claimed 12, wherein the laser beam emitted by the optical measuring device is an infrared laser beam.

14. The module for measuring the thickness of the thermal grease as claimed in claimed 11, wherein the carrying platform is suitable for moving relative to the non-contact measuring device.
